(19) United States
(12) Patent Application Publication
(10) Pub. No.: US 2006/0152760 A1
(43) Pub. Date: Jul. 13, 2006

(54) Printing control apparatus to install printer driver file and method of controlling the same

(76) Inventors: Dong-kyoo Hong, Seoul (KR); Sang-min Lee, Suwon-si (KR); Yong-in Eom, Suwon-si (KR)

Correspondence Address: STANZIONE & KIM, LLP, 919 18TH STREET, N.W., SUITE 440, WASHINGTON, DC, 20006, US

(21) Appl. No.: 11/320,856

(22) Filed: Dec. 30, 2005

(30) Foreign Application Priority Data
Jan. 7, 2005 (KR) 2005-1849

(51) Int. Cl. G06F 3/12

(52) U.S. Cl. 358/1.15; 358/1.13

(57) ABSTRACT

A printing control apparatus and a method of controlling the same include an operating system part, a memory part, a communication interface part to receive a printer driver file from an external device, and a null driver part having an interface to receive and transmit a command and data from and to the operating system part, to receive the printer driver file from the external device, and to load the printer driver file in the memory part to configure a printer driver to drive the printing device. Since the printing control apparatus includes the null driver part to receive and transmit the command and data to control the operating system part and the printing device, it is possible to configure the printer driver of the printing device in the printing control apparatus without requiring a separate process of installing the printer driver.

### CROSS-REFERENCE TO RELATED APPLICATIONS

This application claims the benefit of Korean Patent Application No. 2005-1849, filed on Jan. 7, 2005 in the Korean Intellectual Property Office, the disclosure of which is incorporated herein by reference.

### BACKGROUND OF THE INVENTION

1. Field of the Invention

The present general inventive concept relates to a printing control apparatus and a method of controlling the same. More particularly, the present general inventive concept relates to a printing control apparatus which receives a printer driver file from a printing device or a web server and installs the printer driver file in a designated position of a memory part to form and use a printer driver corresponding to the printer driver file without requiring a separate installment program and process per each printer driver, and a method of controlling the same.

2. Description of the Related Art

Generally, if it is desired to print a document made from a printing control apparatus, such as a computer, via a printing device, such as a printer, the printing control apparatus should have a printer driver for driving the printing device. As a printing command and data are transmitted, the printer driver converts the data into print data recognizable by the printing device and transmits the print data to the printing device so that a printing operation can be performed.

In general, a second printer driver for a second printing device should be re-installed if the second printing device is desired to be used since the printer driver is different for the second printing device. To use a plurality of printing devices in a network, all the printer drivers for the respective printing devices should be installed in the printing control apparatus.

Additionally, a dedicated installation program should be provided for each printer driver since the number of files and the process of installation for each printer driver are different.

In an effort to dissolve the above-described problem, a common-sharable printer driver 110 has been introduced into a printing control apparatus as shown in FIG. 1.

Referring to FIG. 1, the common-sharable printer driver 110 supporting a plurality of printing devices (printer A, printer B, and printer C) with corresponding printer languages, and a printing option may be included in an operating system or installed in the printing control apparatus 100. The common-sharable printer driver 110 comprises a printer information read part 111, a printer information storage part 112, a printer language basic information storage part 113, and a UI configuration part 114.

Hereinafter, operations of the common-sharable printer driver 110 will be explained. The printer information read part 111 reads out information on the printer language and a printer function provided from the connected printing devices (printer A, printer B, and printer C), and the printer information storage part 112 stores the read information.

The printer language basic information storage part 113 extracts a basic value usable in the corresponding printing devices (printer A, printer B, and printer C) or a function setting value composed of maximum and minimum specification values, and transmits the extracted values together with the printer function information to the user interface (UI) configuration part 114.

The UI configuration part 114 resets items and values displayed on a user interface screen using the printer function information and function setting value obtained from the corresponding printing device whenever there is a user's request, and forms an optimized user interface screen to be displayed for a user.

If the user sets a new printing option on the displayed user interface screen and inputs a printing request, the common-sharable printer driver 110 generates print data including the set new printing option and transmits the print data to the printing devices (printer A, printer B, and printer C) to perform a printing operation.

However, it is difficult for the common-sharable printer driver 110 to install all printer driver modules for supporting all existing printing devices, and it is more difficult to design the common-sharable printer driver predicting all functions of newly introduced printing devices since the number of models of the printing devices supportable by the common-sharable printer driver is limited.

Accordingly, the printing control apparatus requires a separate program and process for installing a printer driver supporting the corresponding printing device to use the printing device not supported by the common-sharable printer driver or a newly released printing device.

### SUMMARY OF THE INVENTION

The present general inventive concept provides a printing control apparatus which receives a printer driver file from a printing device or a web server and installs the received printer driver file in a designated position of a memory part to form and use a printer driver corresponding to the printer driver file without requiring a separate installment program and process per each printer driver, and a method of controlling the same.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a printing control apparatus usable with a printing device, the printing control apparatus comprising an operating system part, a memory part, a communication interface part to receive a printer driver file from an external device, and a null driver part having an interface to receive and transmit a command and data from and to the operating system part, to receive the printer driver file from the external device, and to load the printer driver file in the memory part to configure a printer driver corresponding to the printer driver file to drive the printing device.

The external device may be one of one or more printing devices to perform a printing operation according to control of the printer driver, and one or more web servers connected to the communication interface part via a communication network.

Upon receiving the command and data to control the printing device from the operating system part, the null driver part may provide the printer driver of the memory part with the command and data to be converted into print data recognizable by the printing device.

The null driver part may comprises a file loader part to receive the printer driver file from the external device, and an installment part to configure the printer driver in the memory part according to a driver configuration information file included in the printer driver file.

The null driver part may further comprise a search part to search at least one of the printing devices connected to the printing control apparatus and to generate a list of the searched printing devices.

The null driver part may further comprise a UI part to display the list of the printing devices generated from the search part so as to select the printing device to receive the printer driver file corresponding to the selected printing device. Upon receiving the command and the data to control the printing device from the operating system, the null driver part may check if the printer driver has already been configured in the memory part, and if not, the null driver part may receive the printer driver file from the external device.

The null driver part may transmit to the printing device a new printer driver file transmitted from the web server so as to upgrade the printer driver file in the printing device if a version of the new printer driver file from the web server is higher than that of the printer driver file in the printing device.

The foregoing and/or other aspects of the present general inventive concept may also be achieved by providing a method of controlling a printing control apparatus having a certain operating system part and a memory part, the method comprising receiving a command and data to control an external printing device from the operating system part, determining if a printer driver to process the received command and data is configured in the memory part, and if the printer driver has not been configured in the memory part, receiving a printer driver file corresponding to the printer driver from an external device, and loading the printer driver file in the memory part to configure the printer driver.

The external device may be one of one or more printing devices to perform a printing operation according to control of the printer driver and one or more web servers connected to the printing control apparatus via a communication network.

The configuring of the printer driver comprises displaying a list of the one or more printing devices connected to the printing control apparatus to select one of the printing devices, and configuring the printer driver in the memory part according to a configuration information file included in the printer driver file transmitted from the selected printing device.

The method may further comprise transmitting to the printer driver the command and data received from the operating system part to convert the data into print data recognizable by the printing device.

The method may further comprise transmitting the converted print data to the printing device to perform the printing operation.

The method may further comprise transmitting the command and data received from the operating system part to the printer driver to generate a user interface screen to set a printing option corresponding to the print data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an operation of a conventional common-sharable printer driver;

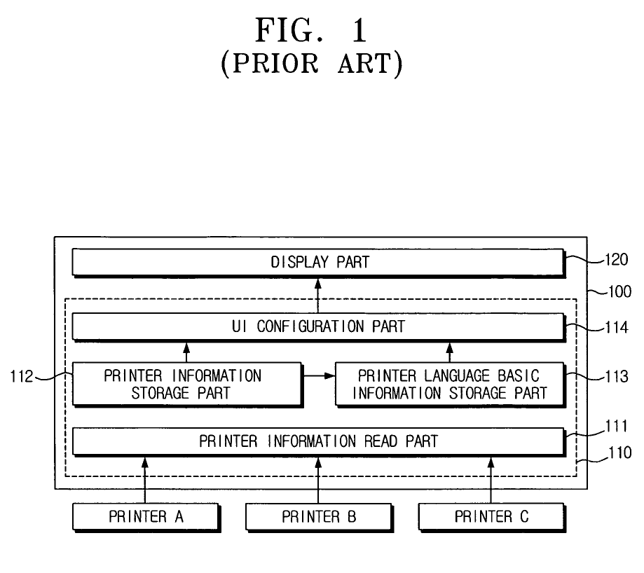

FIG. 2 is a block diagram illustrating a printing system including a printing control apparatus according to an embodiment of the present general inventive concept;

FIG. 3 is a detailed block diagram illustrating the printing control apparatus of FIG. 2; and

FIG. 4 is a flowchart illustrating a control method of a printing control apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

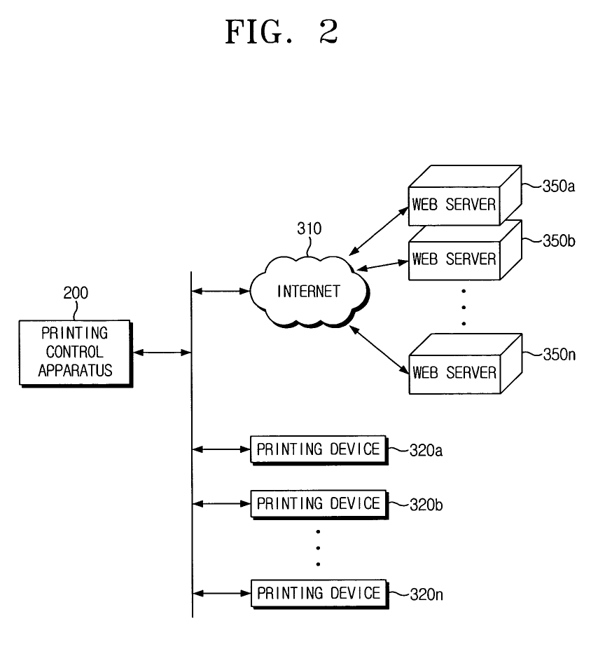

FIG. 2 is a view illustrating a printing system (or an image forming system) including a printing control apparatus 200 according to an embodiment of the present general inventive concept.

Referring to FIG. 2, the printing system comprises one or more printing devices 320a, 320b, . . . , 320n including each printer file, one or more web servers 350a, 30b, . . . , 350n, and the printing control apparatus 200.

As print data corresponding to a document is transmitted from the printing control apparatus 200, the printing devices 320a, 320b, . . . , 302n perform a printing operation according to the print data. The printing devices 320a, 320b, . . . , 320n transmit a printer driver file to the printing control apparatus 200 if it is requested by the printing control apparatus 200. The printer driver file includes a driver configuration information file with information on a function of the corresponding printer driver file. For example, if a file A is a driver file, a file B is a configuration file, a file C is a data file, and a file D is a language monitor, information on the files A, B, C, and D is included in the driver configuration information file, which may be an INF file in Windows system. The driver configuration information file of the printer driver file is used to configure a printer driver in the printing control apparatus 200.

The web servers 350a, 350b, . . . , 350n have therein printer driver files and are connected to the printing control apparatus 200 via a communication network, such as Internet 310 to support (control) the printing devices 320a, 320b, . . . , 320n, and transmits the printer driver files to the printing control apparatus 200 when it is requested from the printing control apparatus 200.

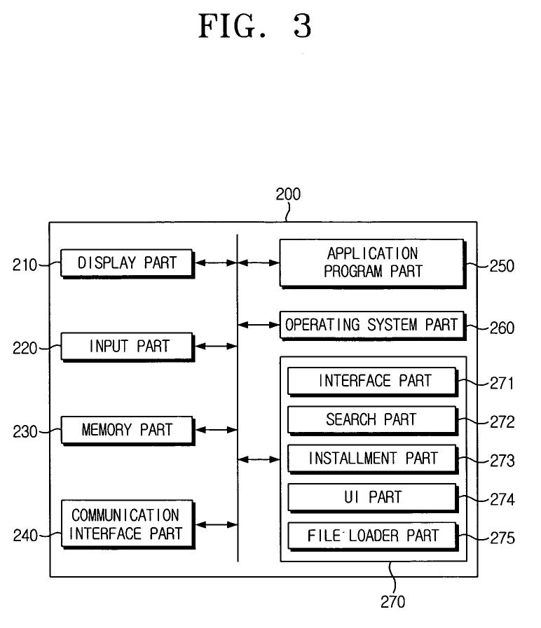

The printing control apparatus 200 of the printing system will be explained with reference to FIG. 3. Referring to FIGS. 2 and 3, the printing control apparatus 200 comprises a display part 210, an input part 220, a memory part 230, a communication interface part 240, an application program part 250, an operating system part 260, and a null driver part 270.

The display part 210 displays information generated from the printing control apparatus 200, and may include a monitor embodied with a Cathode Ray Tube (CRT), a Liquid Crystal Display (LCD), etc.

The input part 220 comprises a plurality of function keys, as a user interface unit, capable of setting or selecting functions of the printing control apparatus 200. A keyboard and a mouse can be used as the input part 220.

The communication interface part 240 is connected to the communication network to transmit and receive the print data to and from the printing devices 320a, 320b, . . . , 320n, and receives the printer driver file from the web servers 350a, 350b, . . . , 350n and the printing devices 320a, 320b, . . . , 320n.

The application program part 250 may be embodied by word processing programs, such as MS word, composes and edits various documents to be printed, and requests the operating system part 260 to print the composed document.

The operating system part 260 monitors and controls each of elements and programs configuring the printing control apparatus 200 to be normally operated, and may be embodied by Windows system such as Window 98, Window NT, Window XP. When a printing operation is requested from the application program part 250, the operating system part 260 according to the present embodiment transmits the command and data to the null driver part 270 so that the printing devices 320a, 320b, . . . , 320n are controlled to perform the requested printing operation. When there is a request corresponding to a printing option set from the application program part 250, the operating system part 260 transmits data including a basic printing option to the null driver part 270 to generate a user interface through which the printing option is set.

The null driver part 270 comprises an interface to transmit and receive commands and data to and from the operating system part 260. The interface may be capable of transmitting and receiving the commands and data which are transmitted to control the printing devices 320a, 320b, . . . , 320n from the operating system part 260. The null driver part 270 receives the printer driver files from the printing devices 320a, 320b, . . . , 320n and the web servers 350a, 350b, . . . , 350n to install printer driver modules corresponding to the respective printer drivers in the printing control apparatus 200 and transmits to each installed module of the printer driver the commands and data transmitted from the operating system part 260 to be processed.

The printer driver module comprises a user interface module to generate a user interface screen to set the printing option, and a rendering module to render the document composed from the application program part 250 to the print data. In other words, the null driver part 270 receives all commands and data to control the printing device, which is an image forming apparatus, and to operate the printer driver according to the control of the operating system part 260, and the printer driver module is installed in the printing control apparatus 200 according to the received printer driver file from the printing devices 320a, 320b, . . . , 320n and the web servers 350a, 350b, . . . , 350n so as to control the printing devices 320a, 320b, . . . , 320n to perform the printing operation.

In specific, the null driver part 270 comprises an interface part 271, a file loader part 275, an installment part 273, a search part 272, and a User Interface (UI) part 274.

The interface part 271 receives the commands and data from the operating system part 260 to control the printing device, and transmits the received commands and data to the printer driver which is stored in the memory part 230 to perform the printing operation.

The search part 272 searches printing devices 320a, 320b, . . . , 320n and the web servers 350a, 350b, . . . , 350n which are connected to the printing control apparatus 200 to generate a list of one or more printing devices capable of loading a new printer driver file if no printer drive has already been configured in the printing control apparatus 200 or a user requests to search a new printing device to receive the printer driver file.

The UI part 274 displays on the display part 210 the list of the printing devices generated from the search part 272 for a user to select the printing device to load the printer driver file. The UI part 274 provides the user interface module of the printer driver of the memory part 230 with an option to select the printing device in addition to the basic printing option supplied from the operating system part 260 such that the user interface screen including an item to select the printing device can be generated.

The file loader part 275 is connected to the printing device 320a, 320b, . . . , 320n or the web server 350a, 350b, . . . , 350n selected by a user to load the printer driver file via the communication interface part 240. The installment part 273 installs the printer driver file in a relevant position of the memory part 230 with reference to the driver configuration information file in the transmitted printer driver file to configure the printer driver of the selected printing device in the printing control apparatus 200.

The null driver part 270 compares versions between a second printer driver file received from the web servers 350a, 350b, . . . , 350n and the printer driver file received from the printing devices 320a, 320b, . . . , 320n and transmits the printer driver file received from the web servers 350a, 350b, . . . , 350n to the printing devices 320a, 320b, . . . , 320n if the version of the printer driver file received from the printing devices 320a, 320b, . . . , 320n is lower than that of the second printer driver file received from the web servers 350a, 350b, . . . , 350n such that an old version of a printer driver file in the printing devices 320a, 320b, . . . , 320n can be upgraded with a new version of the printer driver file.

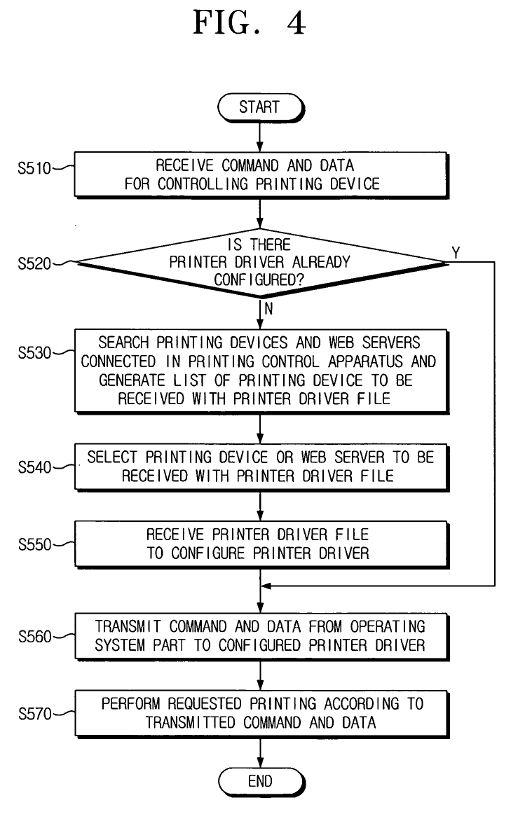

FIG. 4 is a flowchart illustrating a controlling method of a printing control apparatus according to an embodiment of the present general inventive concept.

Referring to FIGS. 2 to 4, upon receiving from the operating system part 260 one or more commands and data to control at least one of the printing device 320a, 320b, . . . , 320n (S510), the null driver part 270 checks if the printer driver corresponding to the printer device has already been configured in the memory part 230 (S520).

If there is no printer driver already configured, the null driver part 270 allows the search part 272 to search the printing devices 320a, 320b, . . . , 320n and the web servers 350a, 350b, . . . , 350n connected to the printing controlling apparatus 200 to generate a list of one or more printing devices to so that the printing control apparatus 200 receives a printer driver file corresponding to the printer device to be controlled (S530). If there is the printer driver already configured, the null driver part 270 transmits to the printer driver the commands and data received from the operating system part 260.

The UI part 274 displays the list of the one or more printing devices generated from the search part 272 on the display part 210 such that a user can select one of the printing devices 320a, 320b, . . . , 320n or one of the web servers 350a, 350b, . . . , 350n so as to receive the printer driver file (S540).

The file loader part 275 receives the printer driver file from the selected printing device, and the installment part 273 configures the printer driver of the selected printing device in the memory part 230 according to the driver configuration information file included in the received printer driver file (S550).

The null driver part 270 transmits to the corresponding module of the printer driver in the memory part 230 the commands and data to control the printing device from the operating system part 260 to perform the printing operation requested from the operating system part 260 (S560, S570). For example, if the printing operation requested from the operating system part 260 is to set a printing option, the null driver part 270 transmits corresponding commands and data to the user interface module to generate the user interface screen through which the printing option is set. If the printing operation requested from the operating system part 260 is to generate the print data about the document to be printed, the null driver part 270 transmits the commands and data to the rendering module to generate the print data recognizable by the printing device and transmits the print data to the corresponding printing device 320a, 320b, 320n.

As described above, if the null driver part 270 has been installed in the printing control apparatus 200 to receive and transmit the commands and data to control the operating system part 260 and the printing device, it is possible to configure a printer driver corresponding to a designated printing device in the printing control apparatus 200 without requiring a separate process of installing the printer driver corresponding to the designated printing device.

Additionally, it is not necessary to install a separate installment program per printer driver file in a printing control apparatus of a printing system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printing control apparatus usable with a printing device, comprising:
an operating system part;
a memory part;
a communication interface part to receive a printer driver file from an external device; and
a null driver part having an interface to receive and transmit a command and data from and to the operating system part, to receive the printer driver file from the external device through the communication interface, and to load the printer driver file in the memory part to configure a printer driver to drive the printing device.

2. The apparatus as claimed in claim 1, wherein, upon receiving the command and data to control the printing device from the operating system part, the null driver part provides the printer driver of the memory part with the command and data to be converted into print data recognizable by the printing device.

3. The apparatus as claimed in claim 1, wherein the external device comprises one of one or more printing devices to perform a printing operation according to control of the printer driver and one or more web servers connected to the communication interface part via a communication network.

4. The apparatus as claimed in claim 3, wherein the null driver part comprises:
a file loader part to receive the printer driver file from the external device; and
an installment part to configure the printer driver in the memory part according to a driver configuration information file included in the printer driver file.

5. The apparatus according to claim 4, wherein the null driver part further comprises:
a search part to search one or more printing devices connected thereto to generate a list of the searched printing devices.

6. The apparatus as claimed in claim 5, wherein the null driver part further comprises:
a UI part to display the list of the printing devices generated from the search part to select one of the printing devices as the printing device to receive the printer driver file.

7. The apparatus as claimed in claim 3, wherein, upon receiving the command and the data to control the printing device from the operating system, the null driver part checks if the printer driver has already been configured in the memory part, and if not, the null driver part receives the printer driver file from the external device.

8. The apparatus as claimed in claim 3, wherein the null driver part transmits to the printing device the printer driver file received from the web server so as to upgrade an existing printer driver file in the printing device if a version of the printer driver file from the web server is higher than that of the existing printer driver file in the printing device.

9. A method of controlling a printing control apparatus having a operating system part and a memory part, the method comprising:
receiving a command and data to control a printing device from the operating system part;
determining if a printer driver to process the received command and data is configured in the memory part; and
if there is no printer driver already configured in the memory part, receiving a printer driver file from an external device and loading the printer driver file in the memory part to configure a printer driver corresponding to the printing device.

10. The method as claimed in claim 9, wherein the external device comprises one of one or more printing devices to perform a printing operation according to control of the printer driver and one or more web servers connected to the printing control apparatus via a communication network.

11. The method as claimed in claim 10, wherein the configuring of the printer driver comprises:
displaying a list of one or more printing devices connected to the printing control apparatus to select one of the one or more printing devices; and
configuring the printer driver in the memory part according to configuration information included in the printer driver file transmitted from the selected printing device.

12. The method as claimed in claim 10, further comprising:
transmitting to the printer driver the command and data received from the operating system part to convert into print data recognizable by the printing device.

13. The method as claimed in claim 12, further comprising:
transmitting the converted print data to the printing device to perform the printing operation.

14. The method as claimed in claim 10, further comprising:
transmitting the command and data received from the operating system part to the printer driver to generate a user interface screen to set a printing option corresponding to the print data.

15. A control apparatus usable with an image forming apparatus in an image forming system, the control apparatus comprising:
an operating system part to generate a command and data to be printed;
a memory part;
a communication interface part to communicate with an external device; and
a null driver part to receive the command and data from the operating system part, to determine whether a printer driver corresponding to the command and data is installed to control an image forming apparatus to print the data, to receive a printer driver file corresponding to the printer driver from the external device through the communication interface part according to a determination of whether the printer driver is installed to control an image forming apparatus to print the data, to install the received printer driver file in a corresponding portion of the memory part, and to load the printer driver file of the memory part to configure the printer driver to drive the image forming apparatus to print a document according to the command and data.

16. The apparatus as claimed in claim 15, wherein the image forming apparatus comprises one or more printing devices connected to the communication interface part, and the null driver part selects one of the one or more printing devices as the image forming apparatus to print the data, and receives a second printer driver file from the selected printing device to drive the selected printing device.

17. The apparatus as claimed in claim 16, wherein the external device comprises one or more web servers connected to the communication interface part through a network or Internet, and the null driver part updates the second printer driver file with the printer driver file when a version of the printer driver file is a new version of the second printer driver file.

18. The apparatus as claimed in claim 15, wherein the external device comprises one or more web servers connected to the communication interface part through a network or Internet, and the null driver part receives one or more printer driver files from the external device through the communication interface part and selects one of the one or more printer driver files as the printer driver file upon determining that the printer driver is not installed to control an image forming apparatus to print the data.

19. The apparatus as claimed in claim 15, wherein the image forming apparatus comprises a plurality of image forming apparatuses, and the null driver part selects one of the plurality of the image forming apparatuses and receives the printer driver file corresponding to the selected image forming apparatus to print the data

20. The apparatus as claimed in claim 15, wherein when the command corresponds to set a print option to print the data, the null driver generates a user interface screen through which the print option is set, and when the command corresponds to print the data, the null driver converts the data into print data recognizable by the image forming apparatus.

21. The apparatus as claimed in claim 15, wherein the control apparatus does not have an installment program corresponding to the printer driver to control the image forming apparatus to print the data.

22. A control apparatus usable with an image forming apparatus in an image forming system, the control apparatus comprising:
an operating system part to generate a command and data to be printed;
a memory part;
a communication interface part to communicate with one or more printing devices and one or more web servers; and
a null driver part to receive the command and data from the operating system part, to determine whether a printer driver corresponding to the command and data is installed, to receive a printer driver file corresponding to the printer driver from one of the one or more printing devices and one or more web servers through the communication interface part according to a determination of whether the printer driver is not installed, to install the received printer driver file in a corresponding portion of the memory part, to select one of the one or more printing devices, and to load the printer driver file of the memory part to configure the printer driver to drive the selected printing device to print a document according to the command and data.
